(19) United States
(12) Patent Application Publication
(10) Pub. No.: US 2012/0301708 A1
(43) Pub. Date: Nov. 29, 2012

(54) Replacement part for satellite optical solar reflectors

(75) Inventors: Sabine Dagras, Ramonville (FR); Monique Guzzoni, Bourg St Bernard (FR); Amandine Rieu, Toulouse (FR)

(73) Assignee: ASTRIUM SAS, Paris (FR)

(21) Appl. No.: 13/482,193

(22) Filed: May 29, 2012

(30) Foreign Application Priority Data
May 26, 2011 (FR) 11 01631

(51) Int. Cl. B32B 7/12; C09J 7/02; B32B 15/08; B05D 5/06; B32B 37/14

(52) U.S. Cl. 428/335; 427/162; 156/278; 428/344; 428/354; 428/457

(57) ABSTRACT

Method for installing a thermo-optical patch on an outer satellite wall; the patch consists of a metal sheet that includes a coat of electrically conductive adhesive on one of its sides and a coat of paint with predefined thermo-optical properties on its other side. A satellite that includes a patch applied to an outer side of a wall of the satellite is also described.

This invention belongs to the field of satellites. It relates more specifically to optical solar reflectors such as those used in telecommunications satellites, in particular.

### PREAMBLE AND PRIOR STATE OF THE ART

Optical Solar Reflectors (OSR's) are used in many satellites. Their function is to act as radiators. They are in the form of squares of a few centimeters per side; they usually consist of an upper layer made of borosilicate glass and a reflecting metal lower layer. Incident solar light goes through the glass and is reflected by the metal layer. The satellite's heat is sent into space by the glass, which is a good infrared emitter.

Using OSR's is justified when maximum heat rejection to space performance is required, in particular in telecommunications satellites.

Most of these optical solar reflectors are fitted during the initial manufacturing of the satellite's panels, over a large portion of their area. To achieve maximum heat rejection capacity, it is often necessary to add further optical solar reflectors at the end of the satellite's integration process.

However, the method for bonding optical solar reflectors (OSR's) onto satellite walls at the integration stage involves a complex implementation process that imposes significant and very taxing planning constraints at the end of a satellite's integration process.

Using paint on the satellite's walls to complete the OSR coating could be considered, but this has the following drawbacks:
The application of paint is long and drawn out (a primer must be applied, followed by eight coats of paint, etc.)
The drying time of the paint is long and implies constraints, such as the impossibility of switching ON the satellite's internal equipment before 24 hours, the reduced ability to rotate the satellite during these 24 hours, etc.
The method is polluting during its implementation and significant means of protection (masking out surrounding areas, etc.) must be installed.

### DESCRIPTION OF THE INVENTION

The proposed invention consists of replacing these optical solar reflectors by white-painted adhesive flexible metal parts.

To this end, the invention envisages a thermo-optical part to be applied to an outer side of said space vehicle; said part comprises at least one sheet, which comprises a coat of adhesive on one of its sides and a coat of paint with predefined thermo-optical and flexibility properties on its other side.

“Space vehicle” means a vehicle designed to travel in orbit. In order to be suitable for use on an outer side of space vehicles, the thermo-optical part must be compatible with the environmental conditions prevalent in orbit or in space: intense solar radiation; temperatures ranging, typically, from −150 to +150°; hard vacuum; in addition to which it must have an operational lifespan similar to that of the satellite, i.e. several years.

“Outer side of a space vehicle wall” means a side pointing towards open space in contrast with an inner side, pointing towards the on-board electronic equipment.

“Flexibility” means the ability of the thermo-optical material layer, once applied to a base, to be handled and gently roller-pressed without the paint cracking or peeling.

In a preferred embodiment, the sheet is made of metal.

Advantageously, the layer of material with predefined thermo-optical and flexibility properties is a coat of white paint.

Because of its good thermo-optical properties, white paint is an interesting substitute for optical solar reflectors, even though the performance it delivers is naturally lower than that of OSR's.

Preferably, the metallized sheet used consists of at least one sheet of aluminum, between 20 and 60 microns thick (50 microns for the preferred material known under the brand name Chofoil—registered trademark), with an initial surface resistivity less than or equal to 0.00200 ohm.

In a preferred embodiment, the coat of adhesive is of pressure-sensitive acrylic type (PSA-type: Pressure Sensitive Adhesive), between 20 and 60 microns thick and loaded so as to be electrically conductive. In this way, the patch also provides electrical continuity between the various parts or surfaces of an outer satellite wall. The initial transverse resistivity of the coat of adhesive and of the metallized sheet is typically less than or equal to 0.0350 ohm.

Even more specifically, the part comprises a self-adhesive layer of a type known under the brand name Cho-Foil CCJ (registered trademark), which comprises a coat of white paint on its side opposite the adhesive side.

Cho-Foil FCJ (registered trademark) is normally used as a material designed to provide electrical continuity between parts located inside a satellite (grounding, cables, etc.) or to form an electromagnetic shield designed to protect electronic parts. This material is designed to withstand temperatures of between −60° and +100° C., making it compatible with use in a space environment.

Alternatively, the sheet is made of at least one sheet of polyimide film, for example of a type known under the brand name kapton (registered trademark).

In a preferred embodiment, the white paint used is a compound-type paint with a silicone base and a zinc oxide-type pigment, for example, that known under the brand name SG122FD (registered trademark).

The invention also envisages a method of installing a thermo-optical part, such as described here, on a wall of a space vehicle, which comprises the following steps:

110—producing a roll of material made of a metal sheet that comprises one coat of conductive adhesive;

200—applying at least one coat of white paint on at least part of the non-adhesive side of this roll.

300—polymerization of the paint;

400—surface preparation of the wall before bonding;

500—cutting out a patch in the painted part to the size of the planned area of application.

600—applying the patch onto the wall of the space vehicle.

In an implementation variant, the method comprises the following steps:

110—producing a roll of material made of a metal sheet that comprises one coat of conductive adhesive;

150—Stamping and cutting out the roll into a square patch four centimeters by four centimeters (standard dimensions for an optical solar reflector).

200—applying at least one coat of white paint onto at least one patch;

300—polymerization of the paint;

400—surface preparation of the wall before bonding;

600—applying the patch onto the wall of the space vehicle.

Here, the cutting out is done before the paint is applied, which avoids damaging the coat of paint after it has dried.

The main feature of this method is that the paint is applied onto a self-adhesive base rather than directly onto the wall of the satellite.

According to another aspect, the invention envisages a space vehicle that comprises at least one thermo-optical part such as described, applied to an outer side of a wall of said satellite.

According to yet another aspect, the invention envisages a use of a thermo-optical part such as described, to be applied as an optical solar reflector on an outer side of a wall of a space vehicle.

### Presentation of the figures

The features and advantages of the invention will become apparent thanks to the following description, which highlights the characteristics of the invention in a non-limiting example of application.

The description is based on the figures in the appendix, which represent:

FIG. 1: schematic of the implementation steps of the method according to the invention.

### DETAILED DESCRIPTION OF AN EMBODIMENT OF THE INVENTION

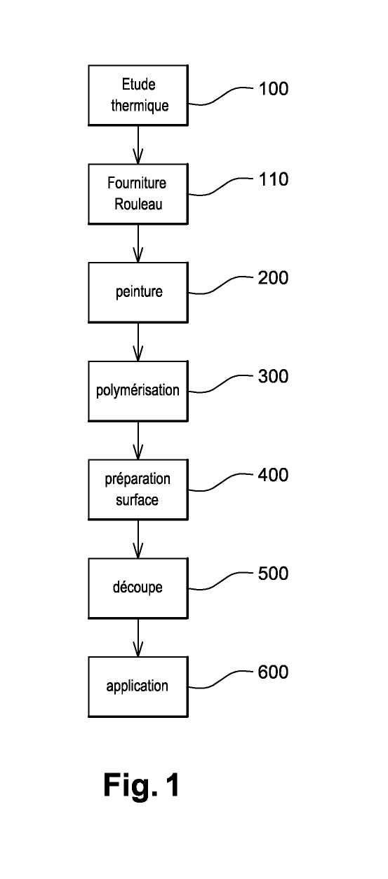

The method for applying patches made of adhesive metal sheets painted white as a substitute for optical solar reflectors on satellites comprises the following steps (see FIG. 1):

100—thermal study for a space vehicle chosen beforehand depending on the operating and environmental conditions foreseen; and evaluation of the optical solar reflectors that may be replaced by white paint. This study verifies that the substitution of patches according to the invention for optical solar reflectors—OSR's —is compatible with the requirements of the satellite. It should be noted that this substitution can be realized in a large number of cases.

110—producing a roll of material made of a metal sheet that comprises one coat of conductive adhesive;

200—applying eight coats of white paint on the non-adhesive side of the metal roll;

300—polymerization of the paint (drying for one week);

400—preparing the substrate's surface (wall of the satellite) before bonding, including for example cleaning with alcohol;

500—cutting out a piece of painted metal sheet comprising a coat of conductive adhesive, to the size of the planned area of application; this cutting out can be easily performed with a cutter or scalpel;

600—applying the cut-out piece to the satellite wall.

In this embodiment, rolls of painted adhesive metal foil are produced without cutting out or punching and the cutting out to specific dimensions is performed at the time the patch is applied. This arrangement is interesting for parts that are cut-out to custom size.

In a variant, both cutting out and punching are performed before applying the paint, to manufacture the patches. One advantage of this arrangement is to subject the painted layer to the least possible stress by avoiding cutting it and to gain time before the parts are assembled, since the patches are pre-cut to standard sizes.

To select the paint, a very flexible white paint is chosen that can be applied onto a non-rigid substrate, which may be cut out or folded. Paint such as the white paint known under the brand name SG122FD (registered trademark) is used in this implementation of the device.

In this implementation, which is described in non-limiting manner, the selected metal sheet comprising a coat of adhesive is a material of a type known under the brand name Chofoil (registered trademark). It was selected because it is totally conductive (its base is a sheet of aluminum and the adhesive mass is charged so as to be conductive). This allows charges to flow properly. In addition, the application of paint onto aluminum is known and mastered.

Lastly, this adhesive is well suited to use outside the satellite as it withstands radiation well. Where it is applied to a telecommunications satellite, the adhesive mass is protected simultaneously by the paint and by the aluminum sheet, which significantly reduces the level of the dose received.

Advantages

To begin with, this application is envisaged to replace some optical solar reflectors. Several tens or even hundreds of parts such as described are to be installed on each satellite concerned during the assembly, integration and test phase.

Subsequently, the use of white- or black-painted metal adhesive parts may be envisaged for numerous other applications (local repairs to paint, taping waveguides or cable strands where there is a proven requirement for good thermo-optical properties, etc.) Where black paint is used, this can be, for example, a Conductive Black Paint (CBP) type: black silicone paint with a black carbon pigment.

This method adds value in all “urgent” cases or for late design changes.

The main advantages of this method are the following:
Ease and speed of implementation. There is a significant time savings in comparison with bonding of an optical solar reflector in the standard way (preparing the adhesive, the substrate, polymerization of the adhesive). Significant savings are also made in comparison with the direct application of paint onto the satellite walls. This is because eight coats of paint must be applied, in general. The device described above thus saves the significant drying time on the satellite.
The satellite is not immobilized during this operation.
Internal equipment can be switched ON just after the parts have been bonded.
If necessary, the paint can be retouched with a brush.
A flexible part is applied, which is therefore not fragile. There is therefore no risk of breakage during the satellite's final assembly operations and there is therefore no need to envisage a method for disbonding and repairing.
Parts of various shapes can be bonded to non-flat surfaces (over satellite inserts, etc.)
The inserts need no longer be blocked (the kapton part can be punctured in the vicinity of the insert, thus avoiding problems caused by venting). Not blocking the inserts produces relatively large savings in both time and mass.
There are no problems with grounding (since the part comprises a conductive adhesive).
The white paint has good thermo-optical properties in comparison with bonding kapton or unpainted self-adhesive metallized film.

1. Method for installing a thermo-optical part on a space vehicle wall, characterized in that it comprises the following steps:
110—producing a roll of material made of a metal sheet that comprises one coat of conductive adhesive;
200—applying at least one coat of white paint on at least part of the non-adhesive side of this roll.
300—polymerization of the paint.

2. Method according to claim 1, characterized in that it comprises the following step:
150—stamping and cutting out the roll produced in step 100 into square patches of standard dimensions for an optical solar reflector.

3. Method according to claim 1, characterized in that it also comprises the following step:
500—cutting out a patch in the part painted and polymerized in step 300 to the size of the planned area of application;

4. Method according to claim 1 characterized in that it also comprises the following steps:
400—surface preparation of the wall before bonding;
600—application of a patch, which has been cut-out in the part, to the wall of the space vehicle.

5. Thermo-optical part produced by a method according to claim 1, characterized in that said thermo-optical part comprises at least one sheet, which comprises a coat of adhesive on one of its sides and a coat of paint with predefined thermo-optical properties on its other side.

6. Thermo-optical part according to claim 5, characterized in that the sheet consists of at least one thickness of metal.

7. Thermo-optical part according to claim 5, characterized in that the coat of paint with predefined thermo-optical properties is a coat of white paint.

8. Thermo-optical part according to claim 5, characterized in that the sheet is a sheet of aluminum between 20 and 60 microns thick.

9. Thermo-optical part according to claim 5, characterized in that the coat of adhesive is loaded so as to be electrically conductive.

10. Thermo-optical part according to claim 5, characterized in that the coat of adhesive is of an acrylic type sensitive to pressure, whose thickness is between 20 and 60 microns.

11. Thermo-optical part according to claim 5, characterized in that the initial transverse resistivity of the coat of adhesive and of the sheet is less than or equal to 0.0350 ohm.

12. Thermo-optical part according to claim 5, characterized in that the white paint used is made of a silicone matrix loaded with zinc oxide pigments.

13. Thermo-optical part according to claim 5, characterized in that the sheet consists of at least one thickness of polyimide film.

14. Space vehicle, characterized in that it comprises at least one thermo-optical part installed according to a method that complies with one of claim 1, applied to an outer surface of one of its walls.
